(19) United States
(12) Patent Application Publication
(10) Pub. No.: US 2016/0023181 A1
(43) Pub. Date: Jan. 28, 2016

(54) GLOBAL RECYCLING OF THE EARTH'S NATURAL RESOURCES

(71) Applicant: Peter Anthony Miller, Gillingham (GB)

(72) Inventor: Peter Anthony Miller, Gillingham (GB)

(21) Appl. No.: 13/261,647

(22) PCT Filed: Nov. 3, 2011
(86) PCT No.: PCT/GB11/01556

§ 371 Date: Apr. 29, 2013

(30) Foreign Application Priority Data
Jun. 29, 2011 (GB) 1111076.4

(51) Int. Cl. B01J 19/00

(52) U.S. Cl. CPC B01J 19/0053

(57) ABSTRACT

The present disclosure deals with is a combination of interconnected innovative technologies for exploiting the advantages of closed cyclic chain reactions on a global scale to solve the contemporary problem of carbon emissions and the earth's diminishing raw resources associated with fossil fuelled power generation and widespread dumping practices. As a first step the surest way to challenge the present monopoly of the fossil fuel industry is to exploit the full potential of photosynthesising processes, whereby carbon remains the key chemical element for fulfilling the needs of contemporary and future civilisations and whereby the means will be available to control the concentration of green house gases at optimal levels in the environment. Envisaged are global recycling trading schemes based on captive carbon processes and systems for the conversion of existing fossil fuelled power stations to cyclic global power generation using photosynthesised fuel, whereby emitted carbon gases are recycled to sites of photosynthesis for further fuel production thereby creating closed cyclic trading systems with the possibility of completely eliminating global greenhouse gas emissions into the environment from power generation.

The further innovations of the present disclosure consist of alternatives to fossilised carbon for transport based on global cyclic photosynthesising systems as well as the production of potable water and a host of carbon based commodities such as furnishings, textiles, pharmaceuticals, chemicals and food production to achieve maximum mitigation of environmental pollution combined with economically viable carbon-based processes.

### BACKGROUND

The world is confronted with a major crossroad regarding TWO intertwined facts of modern life closely linked to contemporary environmental pollution and the rapid disappearance of the natural resources of the earth.

Two major natural resources are at the core of this trend:
1. Fossil fuel for energy generation, transport & carbonaceous products
2. Potable water

Over 4 billion years ago the earth was still a lifeless inhospitable place.

An extensive crust had probably already formed, whereby decreasing surface temperatures caused the condensation of vast amounts of superheated water vapour forming today's oceans charged with dissolved carbon dioxide gas.

The concoction SUN, SEAWATER & CARBON DIOXIDE provided the basis of nature's greatest invention: PHOTOSYNTHESIS.

There is an urgent need for mankind to curb the present combustion of ca. 2 billion tons/annum of fossilized carbon.

For the continued survival on planet-earth, Nature's fortuitous inventions of photosynthesis and the concomitant so-called “carbon neutral recycling process” must now be followed up and improved upon by mankind.

However, the contemporary reckless rate of plundering of the remaining fossilized carbon and mineral reserves in the earth's crust is unsustainable. There are convincing environmental, economic and political reasons for this:

### Environment

The ever-dwindling reserves of fossilized carbon and their concomitant ever increasing price will continue to provide the impetus to ever-increasing intrusive methods of finding and extracting the last traces of fossil carbon in the earth's crust. This trend has already caused irreversible pollution of the remaining fresh water reserves both above and below the earth's surface.

### Economics

The spiralling price of fossil fuels over recent decades is a major contributor to the present economical upheavals and famines. At present fossilized carbon monopolizes not only the global energy market but also provides the basic raw materials for most of the common articles and commodities of everyday human life from clothing and furnishings to chemicals and pharmaceuticals.

### Politics

The contemporary wars and popular uprisings are undeniable evidence of the unsustainable nature of the further plundering of the earth's raw resources.

### THE SCOPE OF THE INVENTION

The purpose of the present disclosure is to provide the means for mankind to remove itself from the natural environmental process already in operation for billions of years and allow nature unhindered to continue its predestined function.

Disclosed is a combination of inventions with the goal of providing the means to isolate and permanently recycle the element carbon and the compound water in the everyday activities of homo-sapiens by providing innovative means for the widespread recycling of carbon and the utilization of non-carbon options for power generation and transport in an increasingly sophisticated and technically based global economy.

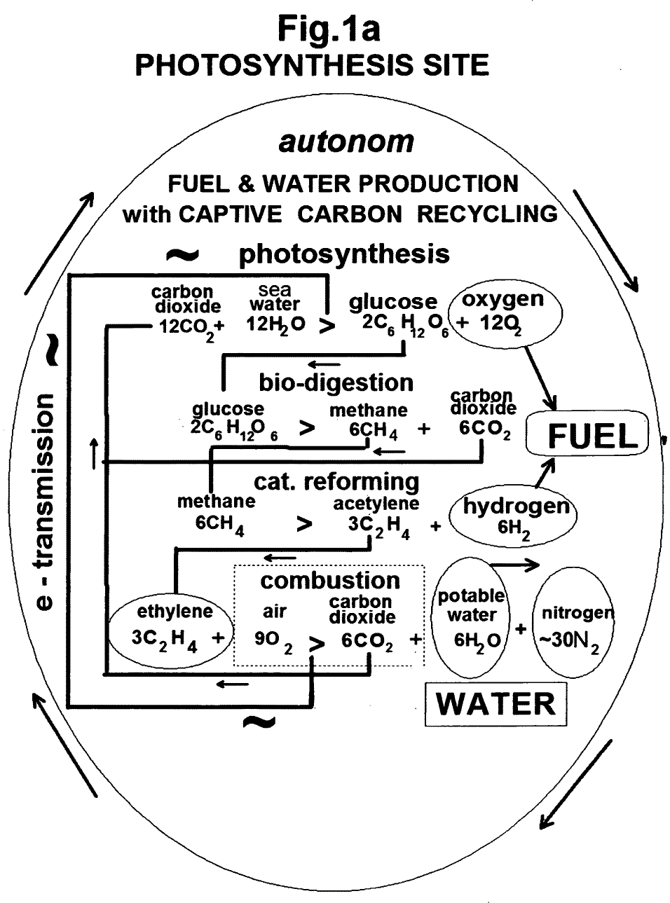

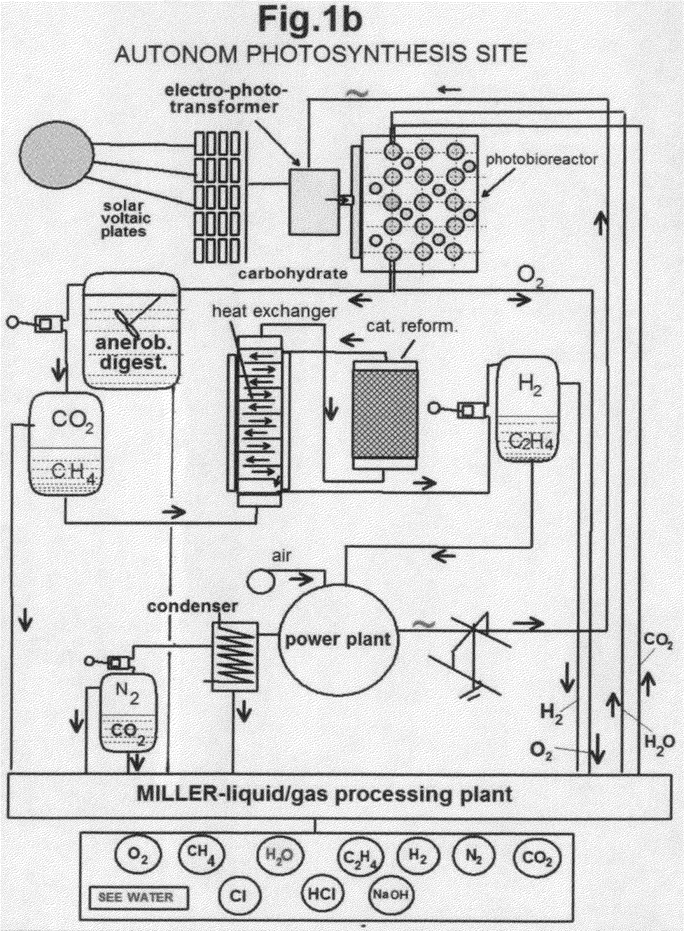

FIGS. 1-6 illustrate schematically autonomic photosynthesizing sites and systems whereby hydrocarbons, biomass and carbonaceous waste generated by photosynthesis are combusted whereby the electric energy and CO₂ emitted are largely recycled to maintain the photosynthesizing processes while simultaneously producing non-carbon fuel as byproducts for energy generation and transport.

Contemporary state of the art technology regarding the exploitation of industrial photosynthesis is in its infancy—today's advances in Gene-Manipulation (GM) suggest at least a possible further 10-fold increase in yield in industrialised photosynthesis. For instance a significant increase in the content of chlorophyll within photosynthesising cell structures of algae and plant life by means of GM R&D could be a rewarding way forward.

With the technology of the present invention a world population of billions of inhabitants could be accommodated. The potentially selfsustainable nature of the sites means that given the necessary long-term investment the existing human and environmental problems could find the long sought after solution. Such a solution can hardly be envisaged for CCS (captive carbon storage), and conventional renewable energy schemes alone.

However, an optimal combination of renewable energy generators to accompany the technology of the present invention may provide an optimal way forward.

The purpose of the following illustrations is to ease the clarification of the disclosed innovations without excessive descriptive passages:

(I) FIGS. 1a/b: Photosynthesising sites for the near autonomous production of unlimited quantities of hydrogen and oxygen as an economically and environmentally viable alternative to fossilized carbon fuel.

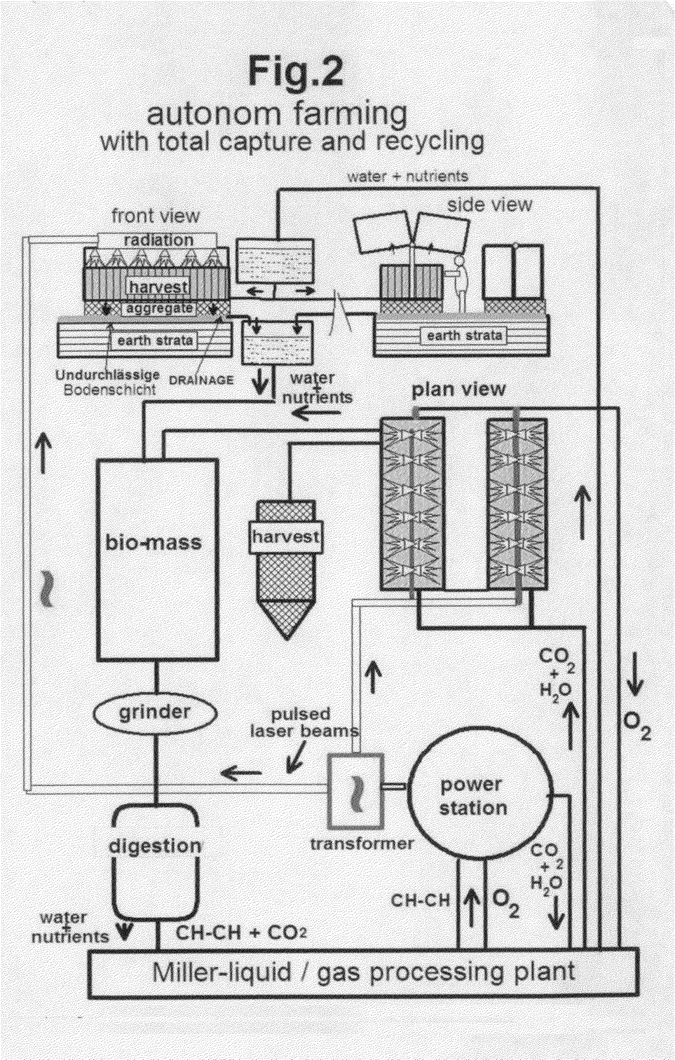

(II) FIG. 2: Near autonomous photosynthesised agricultural products with maximum recycling of carbon, nutrients and irrigation water.

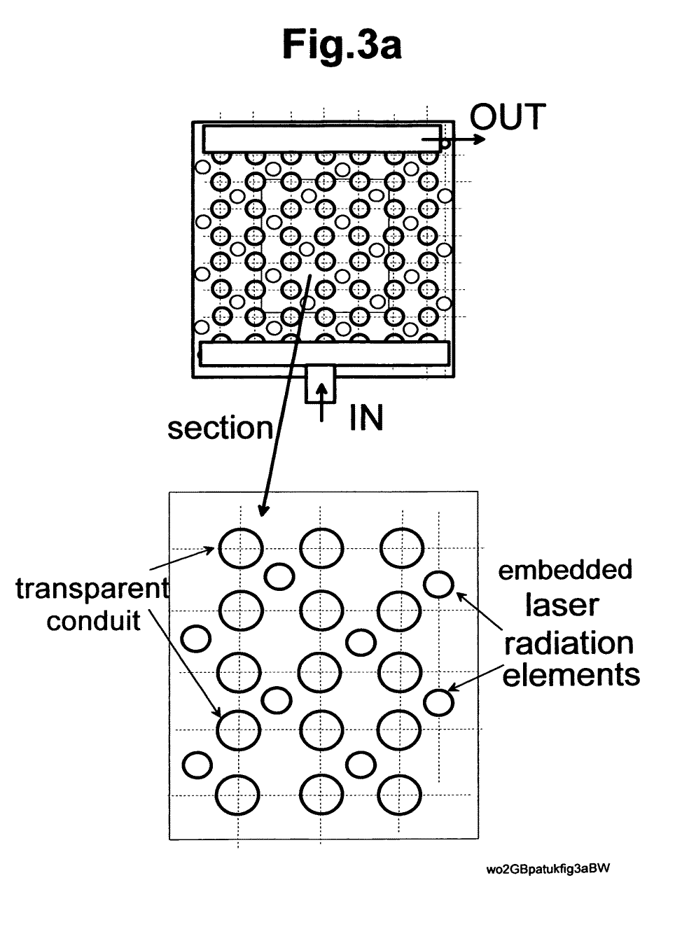

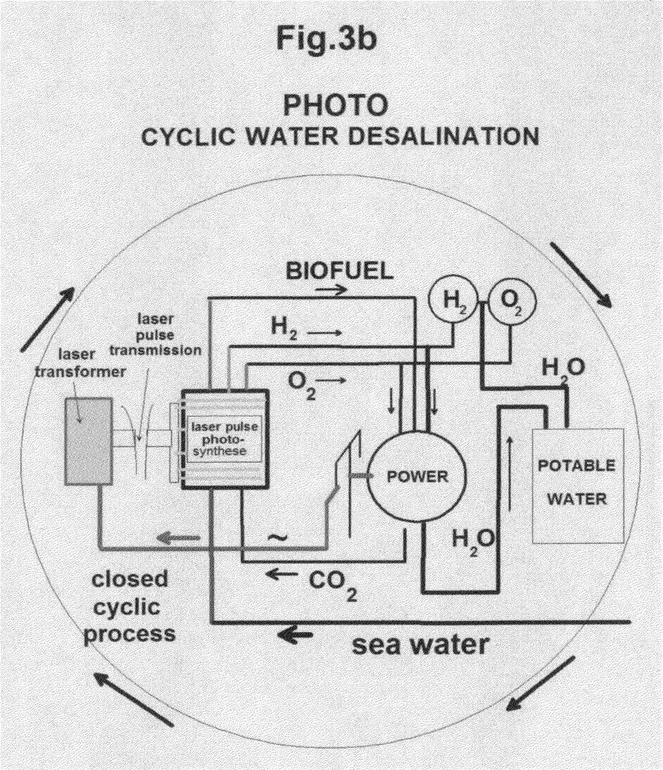

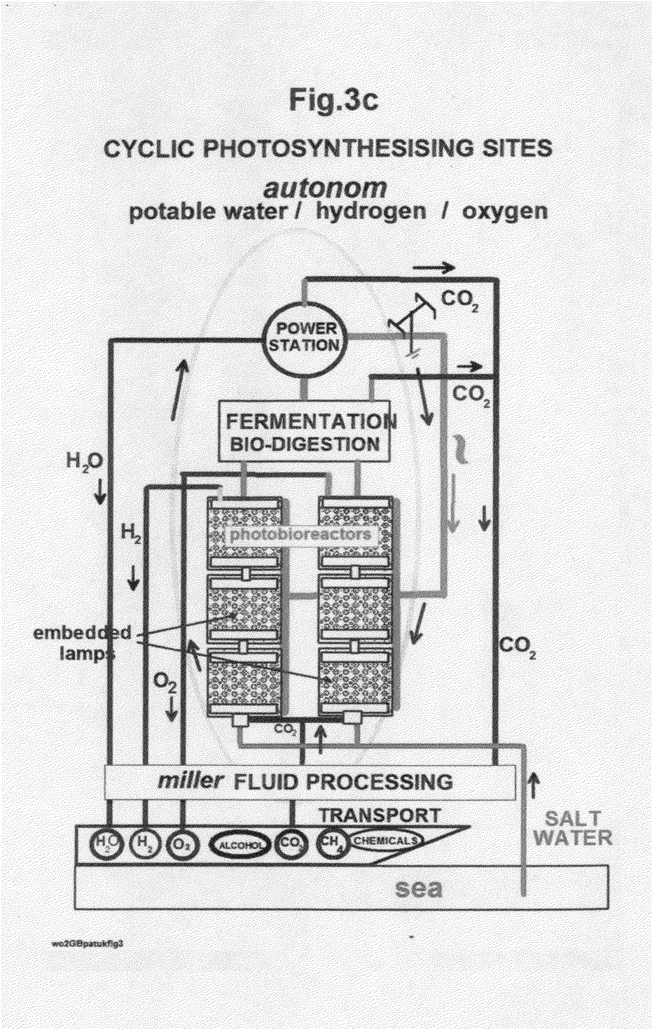

(III) FIG. 3a-c: Autonomous photosynthesised desalination of water and the production of hydrogen and oxygen.

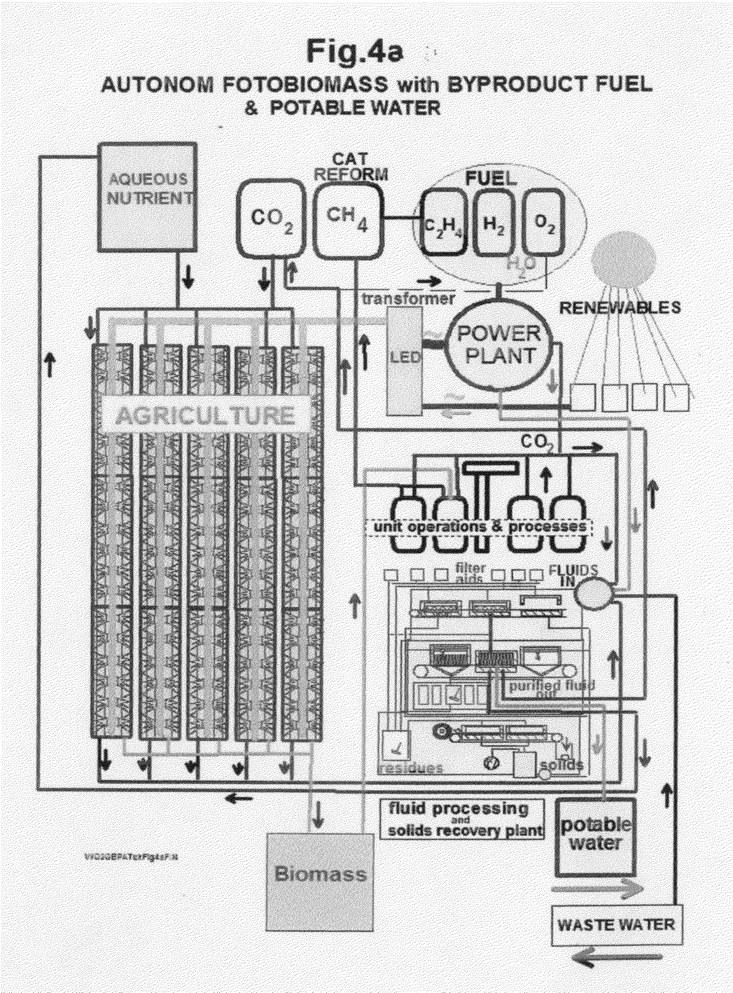

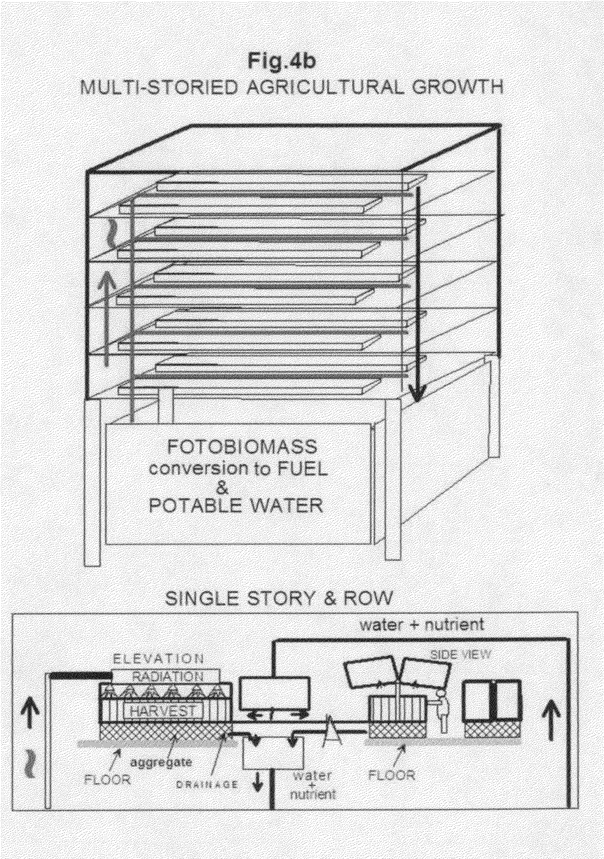

(IV) FIG. 4 Autonomous photosynthesising sites situated in rural areas of industrialised zones of the earth to replace existing centralized power generating plants associated with country-wide networks of e-transmission towers and high-voltage cables thereby providing the opportunity for the decentralisation of not only large scale centralised power supply but also of mega-conurbations and centralized environment-polluting industrialized sites.

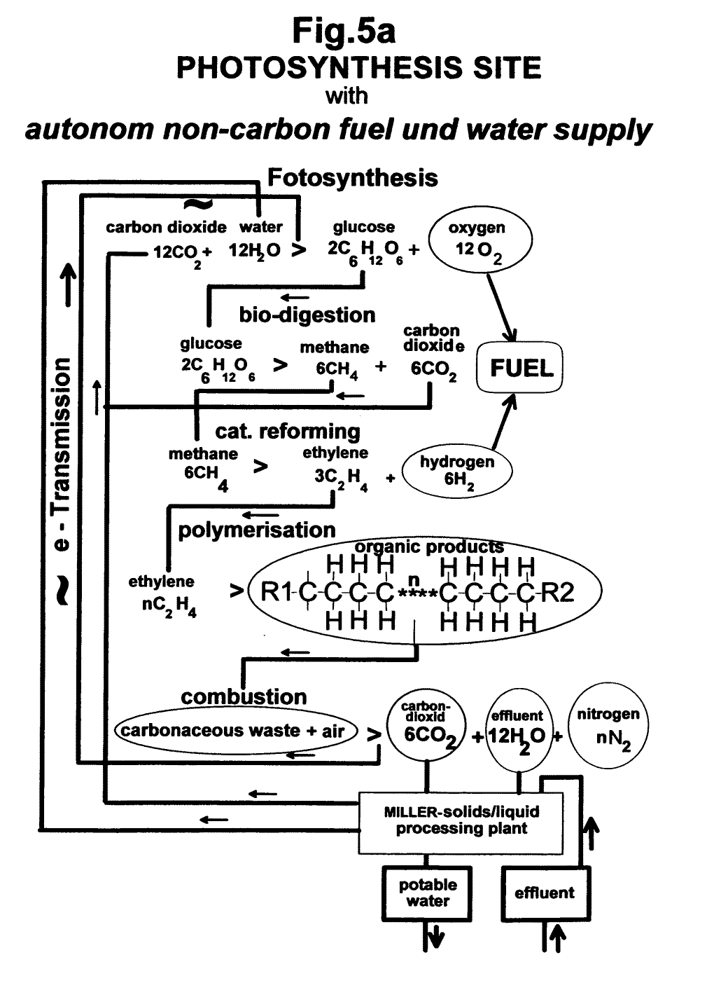

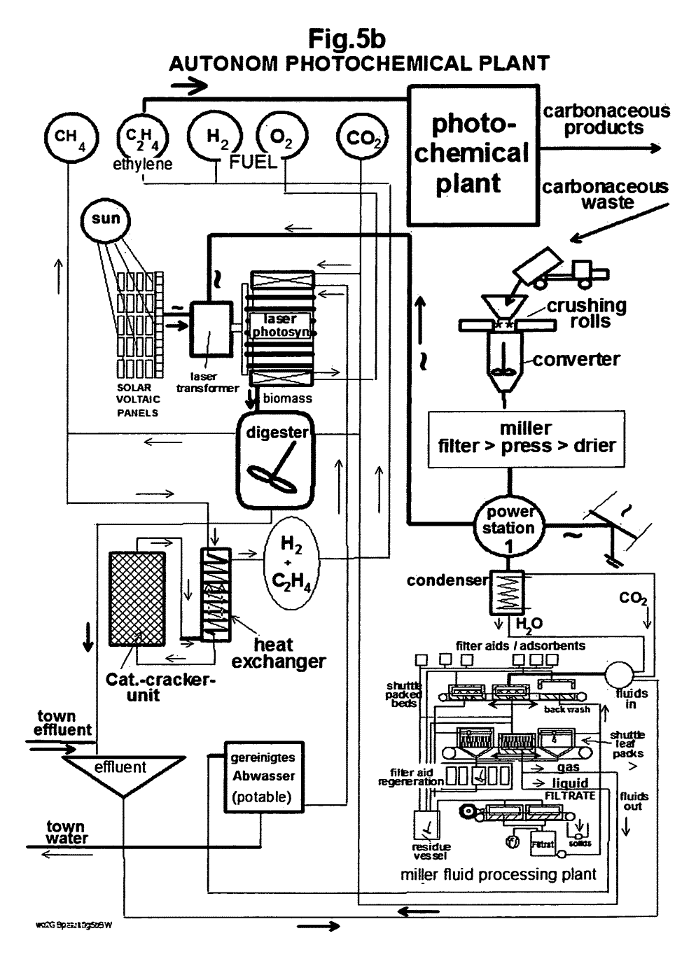

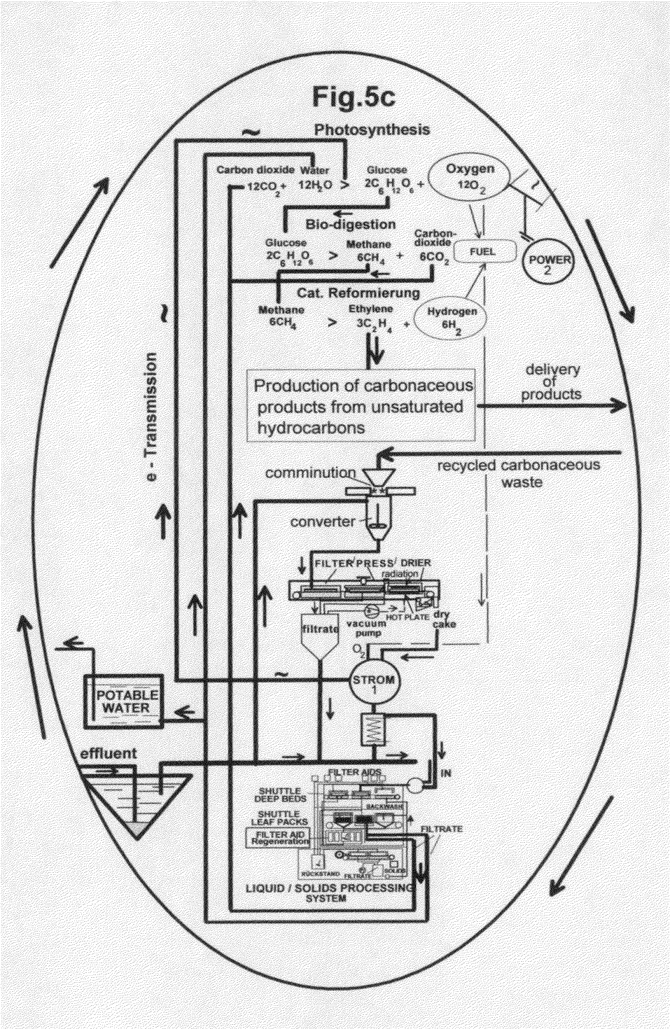

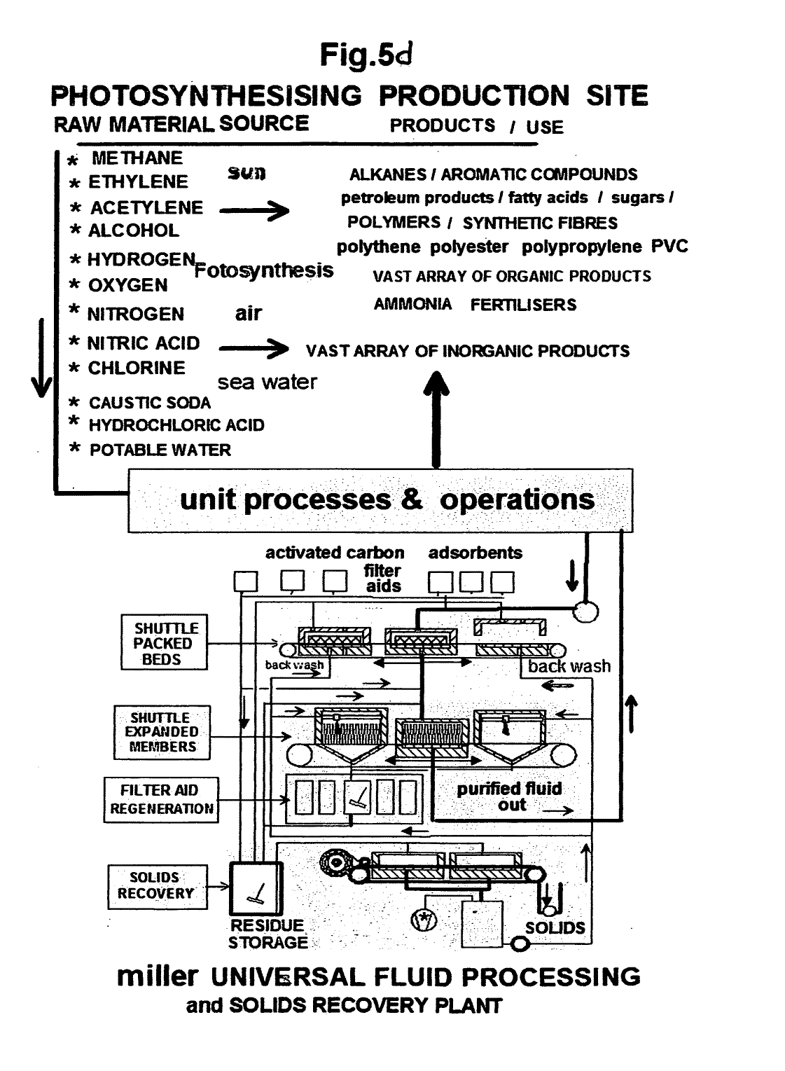

(V) FIG. 5a-d: Photosynthesising production sites centring on multi-process/-product plants, whereby a gamut of chemical and consumer commodities are produced in a largely automated manner, thus enabling the decentralisation of existing chemical processing and fabrication clusters and especially those involved with the processing of carbon-structured products.

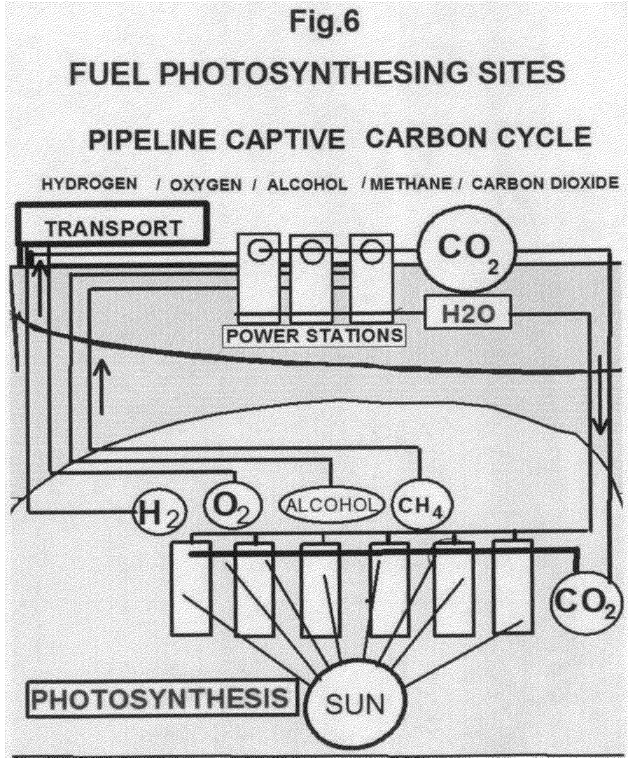

(VI) FIG. 6 Autonomous photosynthesising sites situated optimally in barren, thinly inhabited and often sun-drenched areas from where closed cyclic carbon fuelling of conventional power stations is carried out.

Firstly, the term “autonomic” in this disclosure can be defined as “closely approaching self-sustainability”.

The following set of cyclic reactions and flow lines portrays a typical closed autonomic chemically reactive system that is isolated and in a state of stable equilibrium.

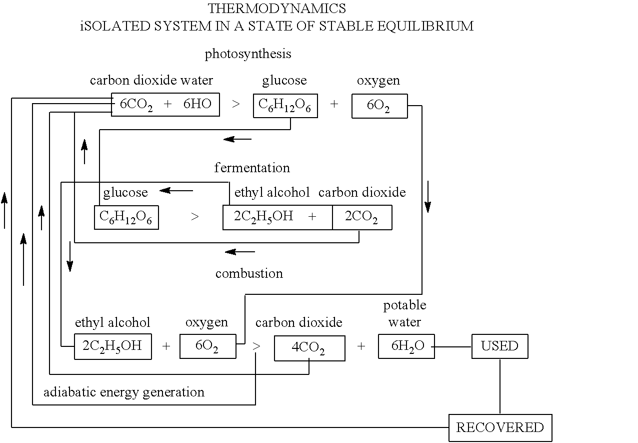

### Application of 1^{st} and 2^{nd} Laws of Thermodynamics

By virtue of the 1^{st} law the energy E of an isolated system is conserved. The energy “consumed” or “degraded” is not lost but according to the 2^{nd} law is converted to heat at a higher level of entropy. Therefore the equation E=mc² also requires that the mass of the system is also conserved. According to the present disclosure the same reasoning can be applied on a global scale whereby closed captive carbon photosynthesising systems generate non-carbon fuels as by-products.

### The Argument for Adiabatic Energy Generation

The efficiencies of the above described cyclic reaction of the present invention are limited by the dictates of the 2^{nd} Law of Thermodynamics involving the concept of “Entropy” when considering isolated systems. As with the concept of “perpetual motion” the present concept of “perpetual cyclic energy generation” can only be approached.

There are therefore significant advantages in employing conventional “renewable energy sources” to supply the “make-up” energy required to achieve perpetual cyclic energy generation as illustrated above:
The transmission of energy by fibre-optics enables the positioning of closely packed embedded LASER or LED elements within bioreactors fitted with transparent or translucent serpentine piping and contained crop growth units thus achieving far more efficient and improved rate of photosynthesis (gm/cm²/sec) of biomass and crops. Preliminary calculations indicate that sets of laser-batteries or gas discharge units fitted to serpentine bioreactors and enclosed farming units with a floor space of for example 50 m² can produce the equivalent quantity of biomass as from 1 km² of open water or irrigated prime agricultural land and with a minimal negative impact on the environment.
Added to this is also the theoretical possibility of the transmittal of high voltage pulsed laser beams with narrow bandwidth over long distances by means of fibre optic technology to enable the photosynthesising process to take place at distant power generating sites. Such light pulses with intermittent periods of light and darkness can be tailored to fulfil the optimal combinations for the photochemical reactions associated with photosynthesising processes.

I) FIGS. 1a/b illustrate flow-sheets based on cyclic captive carbon systems represented as chains of four separate reactions, whereby, in the course of a chain reaction, by-products consisting of oxygen, hydrogen, nitrogen and potable water are produced.

The links of the cyclic chain reaction consist of the following four consecutive reaction steps:
Photosynthesis
Bio-digestion/-fermentation
Catalytic reforming
Combustion

This captive carbon reaction cycle is closed by recycling the carbon dioxide produced in the photosynthesis and bio-digestion steps and the generated electric current in the combustion step for the purpose of irradiation in the photosynthesising stage.

Effectively 12 moles of carbon dioxide produce as by-products 12 moles of oxygen, 6 moles of hydrogen, 6 moles of water and approx. 30 moles of nitrogen.

The flow sheet FIG. 1b of the process shows how the inevitable increase in entropy of the system due to heat losses and power consumption is made up for by external solar voltaic panels feeding into an electro-photo-transformer producing a source of narrow-banded light-beams driving the photosynthesising reaction within the photobioreactor whereby the bulk of the photon energy is provided by the output of a power plant utilising the entire photosynthesised carbon from the bioreactor in the form of unsaturated hydrocarbon as fuel.

The methane from the anaerobic digestion step is catalytically reformed to produce unsaturated hydrocarbons (e.g. ethylene/acetylene) and hydrogen gas that after purification in the liquid/gas processing plant are stored with the oxygen produced in the photobioreactor as fuel.

### Water

FIG. 1a shows that 12 moles of recycled or sea water are used in the photosynthesising equation. This results in the production of 6 moles of potable water in the final combustion step and 6 moles of hydrogen gas in the catalytic reforming third step.

### Economics of Photosynthesized Hydrogen/Oxygen

The production of hydrogen and oxygen as by-products according to the system and process illustrated in FIGS. 1a/b indicates that the predicted selling price of the fuel HYDROGEN & OXYGEN would be in the vicinity of $1 to 10/metric ton whereby the combustion reaction is represented by

2H₂+O₂>2H₂O

and contrasts markedly and favourably with a present selling price of conventional hydrocarbon fuel of the order of $700,−/metric ton

Of special interest is the potential application of fuel cells for the electrification of transport by the combustion of hydrogen and oxygen or air with water as the condensed product of combustion stored and used as a source of trade.

Fuelling land, sea and air transport with hydrogen and oxygen/air would solve much of the existing global political, economical and environmental problems arising from the present global dependency on fossil fuels.

There is still no realistic global solution to the following negative impacts from global fossil fuel combustion:
Rapid dwindling of deposits of fossilized carbon
Greenhouse gas emissions
Water vapour emissions
Heat input into the atmosphere
Increasing marine/land water pollution and spillage from exploration and exploitation

Alone the cost incentive of the HYDROGEN/OXYGEN fuel according to this disclosure would have an enormous positive impact on the global economy as well as the global environment.

II) Cyclic autonomic agriculture

Contemporary global agriculture is still based on practices originating in ancient civilisations and still subject to the repeated drawbacks of drought, floods, pest damage, water shortages and wasted fertiliser.

FIG. 2 illustrates a system of agriculture far removed from the days of the pharaohs and more akin to the days of the internet and space travel.

The element carbon of course is at the core of any terrestrial agriculture and also takes centre stage in the agricultural plan illustrated in FIG. 2

In this system no earth is ploughed and no fertilisers are wasted. In fact the growth units are supported on strips of impervious slab-material that support internally irrigated layers of aggregate material suited for root growth.

The agricultural system in FIG. 2 approaches an autonomic agricultural system based on a scheme according to the principle of TOTAL RECYCLING.

### Operation

Genetically modified (GM) fast growing plants produce edible crops and waste biomass. The crops are consumed whereby the totality of the carbohydrate waste is subjected to biological digestion and/or direct combustion.

The aqueous irrigation with rest-nutrients are purified In the fluid processing plant and recycled to the sealed crop containers irradiated with pulsed laser or gas-discharge electromagnetic beams with a chosen optimal narrow band of wave lengths generated by power stations largely fuelled in effect by the retrieved biowaste.

Harvesting and planting are carried out on a permanent basis round the clock and years, whereby the circulating carbon dioxide is set at an optimal concentration at all times.

The system is essentially closed, cyclic and autonomous and independent of all external weather conditions in all latitudes. There is no known agricultural technology to cope with the increasing contemporary incidences of extreme drought and flooding conditions continuing across the world that are causing serious global food shortages with concomitant prohibitive price increases for staple foodstuffs.

Autonomous farming with total capture and recycling is an answer to the contemporary and looming global food problem.

III) Cyclic autonomic photosynthesized potable water, hydrogen and oxygen from seawater.

### Competitiveness

Potable water, hydrogen and oxygen as byproducts of industrialised cyclic photosynthesis according to the present disclosure have an inherently major advantageous cost structures compared with any other known fuels and sources of desalinated seawater.

FIG. 3: Photobioreactors consist of clusters of transparent serpentine conduits interspersed with sealed transparent cylindrical elements capable of transmitting
reflected solar rays;
laser rays of selected wave length and intensity;
gas discharge rays of selected wave length and intensity
emissions from light diodes with chosen wave lengths and intensity
   for obtaining optimal photosynthesis of suspensions of mainly algal growth within seeded and carbonated aqueous water flowing through the conduits in an upward direction whereby evolved oxygen rises to the upper portions for collection and removal from the reactor.

FIGS. 3b/c: in the presence of sulfur-ions (e.g. sulfides) in the aqueous media making up the photosynthesising process hydrogen instead of oxygen is produced as by-product.

These autonomous photosynthesising sites for the production of non-carbon fuel for both means of transport and energy generation make up the basis for a global network of linked energy and potable water producing facilities.

These cyclic photosynthesising sites produce desalinated water from sea or brackish water with hydrogen and oxygen as by-products and are a potential source of both potable water and non-carbon fuel that could constitute the solution to the present global demand for non-polluting energy generation, transport and potable water.

### The Economic Factor

There is no inherent reason why a kilogram of photosynthesized potable water or hydrogen/oxygen fuel from seawater should not cost in the region of the price of town water in industrialized countries.

### State of the Art of Water Desalination

The operating costs with Reverse Osmosis and Thermal plants are high and can vary widely and additionally they are subject to further serious disadvantages:

1. Membrane fouling of reverse osmosis (RO) plants cause frequent renewal of the elements often leading to failure of the plant and excessive expenditure.

2. The disposal of both raw water pre-treatment and post-treatment sludges and suspensions can cause excessive unplanned operating costs and environmental pollution problems.

3. The fossil fuel energy requirements of both RO and THERMAL desalination of saltwater are high and the resulting carbon emissions indirectly cause additional production costs.

### Photosynthesising Process for Seawater Desalination and Hydrogen and Oxygen Production According to the Invention

### Operation

With this process sea or brackish water partially saturated with purified carbon dioxide is passed through novel photo-synthesising bioreactors where in effect water molecules in the seawater are decomposed by photons to protons and atomic oxygen whereby the protons enter into a cyclic catalysed reaction with carbon dioxide to produce carbohydrates. In effect molecular oxygen is set free as a by-product for storage or recycling to the power generator for combustion with fuel originating in the photo-synthesising bioreactors thus closing the cycle.

The mechanism of demineralisation according to the illustrated processes cannot be compared with conventional thermal and filtration systems. The e-power generated from biomass combustion is converted into electromagnetic radiation preferably consisting of a narrow band of photosynthesising wavelengths (400-500 nm) of laser or gas discharge beams to reconvert the energy into carbohydrates (biomass) for further combustion and energy generation thus completing a system of closed cyclic photosynthesis. Therewith a significantly improved efficiency of the photosynthesising reaction is achieved compared with direct solar radiation. It is reasonable to assume that by applying this technology, at least a five- to tenfold increase in the efficiency of utilising sunlight can be achieved for a given size of bioreactor of the invention.
This means a decisive increase in the productivity of a given photobioreactor is achievable.
An additional advantage is that an effective further doubling of the efficiency of utilisation is achievable with the prospect of round-the-clock uninterrupted production, whereby therefore effectively a 10-20× productivity compared with direct sunlight as a source of light is achievable.
A fuel and potable water producing system largely independent of other external sources of energy is achievable.

With this in mind an autonomic photobioreactor site requiring 1-2 hectares of space in improving on nature's yield of marine algal matter could produce 400 tons/h biomass resulting in ca. 200 tons/hr or ca. 5000 tons/day of potable water according to the present invention.

Accordingly, for a population 50000 ca. 100 litres/person/day of potable-quality is made available.

### Comparative Costs of Desalinated Seawater

Preliminary calculations indicate that the production cost of potable water from saline water by photosynthesis undercuts the nearest competitive process of Reverse Osmosis by approximately 50% with the added advantage that there are no emissions of green house gases and there are no emissions of environmental damaging liquid effluents.

Preliminary approximation of the of the cost comparison of desalinated seawater as potable water with the processes of the invention and state of the art:

1. Process of the invention

| Energy | minimal |
|---|---|
| Capital amort.. | 90% |
| Operating | 10% |

~$0.4/ton (metric)

2. State of the art

| | Thermal | Reverse Osmosis |
|---|---|---|
| Energy | 50% | 30% |
| Capital amort.. | 50% | 40% |
| Operating | 25% | 30% |

~$1.5/ton (metric)

IV) Autonomic photo-biomass with by-product non-carbon fuel and potable water

The contemporary trend to resorting to “biofuels” in the form of vegetable oils, fats and alcohol from the edible parts of food crops have, apart from the high price for such products, caused a market short fall in crop foods available to hunger stricken part of the world.

The cost of harvesting and the continuing need for extra earth fertilisation and irrigation over extensive land areas have hindered the realisation of such proposed solution to the fossil fuel crises.

In addition the green house gas emissions of biofuel combustion are almost identical to that of fossil fuels.

FIG. 4a illustrates schematically an autonomous enclosed photosynthesising site suitable for satisfying these fuel and potable water demands without detriment to the environment.

Such covered autonomous agricultural and production facilities can produce, in addition to biomass, a wide variety of agricultural food products.

These photosynthesising sites can be ideally established for supporting clusters of existing small-to medium-sized communities in existing industrialized or developing countries

For example hundreds of such sites spread over a typical industrialised landscape would achieve the decentralization of civilian and industrial demand for energy with the complete elimination of greenhouse gas emissions, effluent pollution and the need for fossil fuels. Each site could be capable of comprehensively supporting at least a surrounding population of ca. 100,000.

FIG. 4b illustrates schematically a space saving and highly automated system for the same photosynthesising purposes.

These multi-storied autonomic photosynthesising sites are predestined to solve the problems associated with today's agricultural practices:
Independent of weather conditions
Pest-free conditions of growth enabling the elimination of pesticides
Complete recovery and recycling of nutrient irrigation
High degree of automation (harvesting, bed renewal, planting, irrigation)
Large tracts of previous agricultural land can be returned to natural ecological landscapes

V) FIGS. 5a-d represent the reactive concept and flow-sheets of industrial units for the realisation of recyclable carbonaceous products based on photosynthesis.

Illustrated is an array of carbonaceous products for trading purposes that are produced in photosynthesising production facilities including standardised universal fluid and solids processing equipment such as reactor-, distillation-, heat exchanger-units, with CIP (cleaning in place) facilities, whereby shuttle packed beds carry out unit operations involving adsorption, ion-exchange, catalysis, drying operations traditionally carried out by custom made packed towers, columns, cylinders specialising in single products.

These sites carry out closed cyclic chain reactions with the following reaction steps:
photosynthesis,
bio-digestion,
catalytic reforming,
polymerisation
combustion
   whereby provision is made for the production of a comprehensive range of carbon based products.

### Sequence of Operations

In the first photosynthesising step carbon recycled as carbon dioxide is fixed as carbohydrates in photobioreactors, whereby producing oxygen as a byproduct.
In the second link of the chain-reaction carbohydrates are digested or fermented to produce hydrocarbons and carbon dioxide;
In the third link of the chain-reaction the hydrocarbons are catalytically reformed to produce unsaturated hydrocarbon compounds with at least hydrogen gas as a byproduct
In the fourth link of the chain reaction the unsaturated hydrocarbon compounds are polymerised to produce a wide range of carbonaceous compounds and products of commercial value suitable for recycling after use
in the final link of the chain-reaction, recycled waste carbonaceous matter and products are combusted to generate electricity with water and nitrogen as byproducts whereby the generated electricity provides the energy for irradiating the photosynthesising step thus largely closing the energy cycle, wherewith the carbon dioxide emitted in the digestion and combustion processes is recycled to the photobioreactors to close the carbon cycle

In this mode the unsaturated hydrocarbon products from catalytic reforming are polymerised to produce a large range of organic compounds analogous to the product-range of contemporary petrochemical complexes whereby the solid and liquid products consisting of polymeric plastic materials and conventional chemicals after use are to a maximum extent directly or indirectly recycled to produce fuel for combustion and e-energy generation for further photosynthesis.

Today's trend towards centralization of energy generation, industries, financial districts and burgeoning population conurbations are becoming increasingly threatening to the stability of global economies.

The need for decentralization has been on political agendas for many decades, however state of the art technology is not suited for achieving such plans and coupled with the lack of backing for protagonists of innovative technology no promising long term plans have been put in place.

Progress up till now has mainly consisted of the subsidized expansion of expensive old technologies intended eventually to compete with the ever-increasing rise in the cost structure of conventional fossil fuel based energy generation with almost no regard to the ever-burgeoning rising prices of carbon-based products and the accompanying ever-increasing environmental damage of emissions and waste-dumping into the environment, the earth's crust and seas.

The key to a breakthrough according to the present disclosure is the realisation of multi-product and multi-purpose plants to “turn back the pricing clock” with marked price reductions of the commodities energy, fuel and recyclable carbonaceous and many inorganic products.

The medium term plan is to replace fossil carbon by photosynthesised carbon and non-carbon fuel within the next two decades.

Over the past century we have witnessed an explosion in the replacement of naturally occurring products from plant and animal sources by synthesised products based fossilised carbon. Huge fossil fuel, chemical and pharmaceutical complexes and cartels now dominate the production of the bulk of synthesised commodities ranging from pharmaceuticals, plastics, fibres, solvents, paints, surfactants disinfectants, pharmaceuticals, pesticides, etc. A multitude of such production facilities are also the source of the contemporary most dangerous pollution of land, sea and air resources of the planet.

However the most serious contemporary dilemma facing these cartels is the rapid disappearance and ever increasing cost of suitable fossil carbon in the earth's crust as basis of the entire carbon-based industrial complex.

These problems can be solved by the establishment of multi-product and -purpose plants based on photosynthesising processes with the comprehensive recycling of carbon and all other valuable elements making up the table of elements.

FIG. 5d illustrates a plan for the production of a large variety of differing photochemical products each for instance on a weekly or daily basis over the course of a year. The key to this plan can be seen in the innovative concept (already disclosed in WO2009/034365 and GB0821653) whereby fluid processing, purification and recycling and solids recovery systems and apparatus capable of handling a wide range of operational requirements comprise

“bands arranged to intermittently move over plane, pervious support members, whereby in the stationary state elements vertically moveable with respect to the pervious support members engage the periphery of the stationary filter band to seal the overlying sections, thereby forming a space into which fluid is delivered and allowed to exit through the section of filter band by means of pressure differential; whereby alternatively the upper plane of the sealed section of stationary band is made integral with an overlying fluid purification member and whereby the section of the stationary band is transferable to one or more separately located planar pervious support members enabling further distinctive and simultaneous operational procedures to be carried out with the purification member or the section of band and/or the thereon deposited solids' materials.”

An important component of the overall strategy of these sites is not only to decentralise industrial complexes but also to provide the means for the decentralisation of the centuries-long continuing trend towards burgeoning over-concentration of human mega-conglomerations across the globe. The further major goal of the present disclosure is to replace the ever burgeoning centralised PETROCHEMICAL cartels and complexes with decentralised photosynthesising PHOTOCHEMICAL sites dispersed over wide areas of the globe with the means for the catalytic reforming of photosynthesised methane, alcohol, etc. to a large range of organic chemicals
as fuel for energy generation
for the indirect isolation of mole-equivalent quantities of hydrogen, oxygen for transport and energy generation application as well as equivalent mole-quantities of nitrogen and potable water

Ethylene and acetylene produced by means of catalytic reforming of methane with hydrogen as a by-product are central building blocks for the production of a large range of organic and inorganic chemicals e.g. solvents, pharmaceuticals, plastics, fibres, beverages, fertilisers, oxygen, for industrial and domestic use.

VI) FIG. 6 illustrates photosynthesizing sites for the conversion of existing fossil fuel power plants to CAPTIVE CARBON RECYCLING mode of operation.

The present infrastructure associated with fossil fuel production, energy generation and distribution represents an investment perhaps in the region of hundreds of trillions of dollars or euros. Existing fossil fuel polluting power plants have the option of importing or producing on-site recycled photosynthesized fuel to maintain a large proportion of existing power stations.

The present disclosure deals with the means for exploiting the advantages of closed cycle chain reactions on a global scale to solve not only the ever diminishing reserves of fossil fuel deposits and existing emission problems but also the increasing global dependency on the ever increasing manufactured carbonaceous products.

Emissions into the environment are thus avoided on a global scale while the economic advantages of a carbon led economy are preserved.

Carbon dioxide also becomes a valuable global trading commodity, whereby the current combustion of ca. 2 billion tons/year of carbon with the accompanying carbon emissions could conceivably be cut to near zero over the coming decades and therewith instead of being a scourge on humanity carbon dioxide will become valuable much sought after commodity.

The implications go much further:

Carbon dioxide, seawater and solar energy is the concoction of nature that led to nature's success. It was mainly from this combination that life on earth evolved and thrived and by building on and exploiting nature's accomplishment we can assure our future successful existence.

The almost unimaginable prospect of transporting seawater through networks of conduits throughout existing landmasses to provide new productive human habitation and energy generation may transcend science fiction and become a reality.

The inherent uncertainties concerning trends of climate change makes it imperative to provide new affordable sources of pure water as well as emission-free energy and transport for present and future generations that are unchanging, reliable and sustainable.

The combination of the sun, carbon dioxide and seawater can fulfil these requirements.

1. Globally located photosynthesising sites consisting of closed cyclic systems to mitigate manmade climate change tendencies, solve environmental pollution and scarcity of natural resources especially fossilised carbon, food and potable water; thereby providing the basis for the decentralisation of industrial and urban mega-complexes by means of combinations of the following technologies:
a) means for achieving the global autonomous production of non-carbon fuel and potable water;
b) means to achieve global autonomous agricultural sites;
c) means for the realisation of global autonomous production of potable water from seawater;
d) means for achieving the global autonomous production of biomass for the production of non-carbon fuel and potable water;
e) means for the realisation of closed global carbon cycles, autonomous production of carbonaceous products suitable for recycling as fuel for firing power stations thereby decisively contributing to the realisation of closed global carbon cycles for energy generation, agriculture, carbonaceous products and the availability of potable water.
f) means for the conversion of global fossil fuelled power stations to autonomous captive carbon power stations.

2. Photosynthesising sites for the autonomous production of non-carbon fuel and potable water according to claim 1a) and FIGS. 1a/b, whereby in a closed set of linked cyclic chemical reactions
firstly, carbon recycled as carbon dioxide is fixed as carbohydrates in photobioreactors, thereby producing oxygen as a byproduct
whereby in the second link of the chain-reaction carbohydrates are digested or fermented to produce hydrocarbons and carbon dioxide;
whereby in the third link of the chain-reaction the hydrocarbons are catalytically reformed to produce unsaturated hydrocarbon compounds with at least hydrogen gas as a byproduct;
whereby in the forth and final link of the chain-reaction, reformed unsaturated hydrocarbons are combusted to generate electricity with water vapour and nitrogen as byproducts; whereby the generated electricity provides the energy for irradiating the photosynthesising step thus thermodynamically closing the energy cycle, whereby the carbon dioxide emitted in the digestion and combustion processes is recycled to the photobioreactors to thermodynamically close the autonomous carbon cycle.

3. Photosynthesising sites for contained agricultural crop growth according to claim 1b) and FIG. 2, whereby water, nutrients, carbon dioxide and biomass of the process are recycled on a permanent basis; whereby the recycled biomass provides the energy for the photo-irradiation of the crops to approach the condition of thermodynamic autonomous closed systems

4. Photosynthesising sites for autonomous generation of potable water from seawater according to claim 1c) and FIG. 3, whereby electric power generated from photosynthesised biomass is converted to pulsed optical beams of optimal electromagnetic wavelength for the irradiation of enclosed photosynthesising systems with salt free water, oxygen and hydrogen as by-products.

5. Autonomous photosynthesising site for the enhanced growth-rate of biomass on a large scale according to claim 1d) and FIG. 4 where electric power from both power stations and renewable sources is transformed to pulsed narrow beams of optimised photosynthesising wavelengths to produce biomass in sealed industrial sized agricultural containers arranged either at ground level or in multi-storied buildings.

6. Photosynthesising sites according to claim 1e) and FIG. 5 whereby provision is made for the autonomous production of a comprehensive range of carbon based products, whereby in a closed set of linked cyclic chemical reactions
firstly, carbon recycled as carbon dioxide is fixed as carbohydrates in photobioreactors, thereby producing oxygen as a byproduct;
whereby in the second link of the chain-reaction, carbohydrates are digested or fermented to produce hydrocarbons and carbon dioxide;
whereby in the third link of the chain-reaction the hydrocarbons are catalytically reformed to produce unsaturated hydrocarbon compounds with at least hydrogen gas as a byproduct;
whereby in the forth link of the chain reaction the unsaturated hydrocarbon compounds are polymerised to produce a wide range of carbonaceous compounds and products for commercial purposes suitable for recycling as carbonaceous fuel after use;
whereby in the fifth and final link of the chain-reaction, recycled waste carbonaceous matter and products are combusted to generate electricity with water vapour and nitrogen as byproducts; whereby the generated electricity provides the energy for irradiating the photosynthesising step thus largely closing the energy cycle, wherewith the carbon dioxide emitted in the process is recycled to the photosynthesising step to close the carbon cycle

7. Photosynthesising sites according to claim 1f) and FIG. 6, whereby existing global carbon fuelled power stations are converted to non-polluting captive carbon or non-carbon combustion systems.
